(19) United States
(12) Patent Application Publication
(10) Pub. No.: US 2013/0061524 A1
(43) Pub. Date: Mar. 14, 2013

(54) DOOR DEVICE FOR VEHICLE

(71) Applicant: Takashi Yano, Tokyo (JP)

(72) Inventor: Takashi Yano, Tokyo (JP)

(21) Appl. No.: 13/583,318

(22) PCT Filed: Mar. 7, 2011
(86) PCT No.: PCT/JP2011/055270

§ 371 Date: Sep. 7, 2012

(30) Foreign Application Priority Data
Mar. 8, 2010 (JP) 2010-050457

(51) Int. Cl. B60J 5/04

(52) U.S. Cl. CPC B60J 5/0472
USPC 49/192

(57) ABSTRACT

A 2-step swing style vehicle door device includes a coupling means having a link, one coupled to the rear end of the opening of the vehicle body and the other end coupled to the door, and can singly cover, in a direction from the front to the rear of the vehicle, a range corresponding to two rows of seats that are arranged in the front and rear in the vehicle body. This vehicle door device transitions between a first state in which the door is closed, a second state in which the door is opened within a range corresponding to the front seat in the direction from the front to the rear of the vehicle body, and a third state in which the door is opened within a range corresponding to both the front and rear seats in the direction from the front to the rear of the vehicle body.

### FIELD OF THE ART

The present invention relates to an opening/closing device for the doors of a vehicle.

### BACKGROUND ART

The vehicle door device of the present invention relates to a long door of a vehicle, particularly, of a coupe car, in which the long door can singly cover, in a direction from the front to the rear of the vehicle, a range corresponding to two rows of seats that are arranged in the front and in the rear in a vehicle body, so that the vehicle door device of this invention can realize a B-pillarless door design and can allow a passenger to easily get in the rear seat of the vehicle and easily get out of the rear seat in a state in which another passenger is sitting in a front seat.

In the related art, to open and close such a long door that is provided in a side surface of the vehicle, the following three techniques have been proposed, in which a first technique provides a gull-wing door which has not yet been practically produced or marketed, but was proposed as a concept model, such as the Citroen Hypnos Concept (Paris Motor Show 2008) and the Hybrid Tourer Concept of Fuji Heavy Industries (Tokyo Motor Show 2009). In the above-mentioned concept models, due to the design limitations imposed on the door, when in an open state the door is supported only by a hinge that is provided in an upper end of the door. However, such a long gull-wing door is problematic in that, first, the door requires the hinge that is provided in the upper end of the door so as to open or close the door so that problems occur in the strength of the roof of a vehicle body and in the strength of a door frame. Second, such a long gull-wing door requires a structure for supporting the door so that both a door front pillar (A-pillar) and a door rear pillar (B-pillar) undesirably become thick and the thick pillars increase the weight of the vehicle body and the weight of the door, and raise the centers of gravity of the vehicle body and the door.

A second technique provides a long door which can open forwards using a double hinge, thereby providing a large door opening capable of allowing a passenger to easily assume position in the rear seat of the vehicle and to easily get out from the rear seat position. An example of a vehicle having such a long door is the Renault Avantime (production in France of this model was discontinued in 2004). The Renault Avantime has a long door of 1.4 m length that opens forwards; however, unlike the vehicle door device of the present invention, the long door of the Renault Avantime does not singly cover, in a direction from the front to the rear of the vehicle, a range corresponding to two rows of seats that are arranged in the front and in the rear in a vehicle body. Therefore, to allow a passenger to take up position in the rear seat of the vehicle or to get out from the rear seat, it is required to move or collapse a front seat 2. Further, to allow a passenger to take the front seat 2 or to get out of the front seat 2, it is required to increase the size of the door opening. However, the increase in the size of the door opening results in having to provide a large space in the side surface of the vehicle body. Examples of patent documents disclosing vehicle door devices using such a double hinge are patent document 1, patent document 2 and patent document 3. The doors disclosed in the patent documents 1, 2 and 3 are unrelated with the long door of the present invention and cannot allow a passenger to easily take the rear seat of the vehicle or to easily get out of the rear seat in a state in which another passenger is sitting in the front seat.

Patent Document 1: Japanese Patent Application Publication No. Hei. 5-112126;
Patent Document 2: Japanese Patent Application Publication No. Hei. 5-112129; and
Patent Document 3: Japanese Patent Application Publication No. Hei. 5-113074.

A third technique provides a long double door which has not yet been produced, marketed or proposed as a concept model. Examples of patent documents which disclose such a long double door that can singly cover, in a direction from the front to the rear of a vehicle, a range corresponding to two rows of seats that are arranged in the front and in the rear in a vehicle body are patent document 4 and patent document 5. However, such a long double door is problematic in that, when a passenger gets in or out of the front seat and another passenger gets in or gets out of the rear seat, the door should be closed once after one passenger gets in or out of one of the front and rear seats and, thereafter, the door should be closed and opened again so as to allow another passenger to get in or out of the remaining one of the front and rear seats, due to the presence of elements that are provided in the vehicle body so that the door can open, close and be supported.

### Patent Document 4: WO 2005/111352; and

### Patent Document 5: Japanese Patent Application Publication No. 2008-174224.

### DISCLOSURE OF THE INVENTION

### Problems to be Solved by the Invention

Accordingly, the present invention is intended to propose a practical long door of a vehicle, particularly, a four-seater coupe passenger vehicle, which can allow a passenger to easily get in a rear seat of the vehicle and easily get out of the rear seat in a state in which another passenger is sitting in a front seat, and which can solve the problems experienced in patent document 5 in that, when a passenger gets in or out of the front seat 2 and another passenger gets in or out of the rear seat 3, a door should be closed once after one passenger gets in or out of one of the front and rear seats and, thereafter, the door should be closed and opened again so as to allow another passenger to get in or out of the remaining one of the front and rear seats, and which can realize a simple and light structure of the long door in consideration of the fact that most passengers of coupe cars place a lot of value on the comfort of the front seat 2 rather than that of the rear seat 3.

### Means to Solve the Problems

A long door is opened in such a way that the door can be opened within a range corresponding to a front seat in a general state, but can be opened within a range corresponding to the front and rear seats when necessary, so that the vehicle door device disclosed in patent document 5 is constructed to realize four changes, in which a first change is intended to change from a double door to a front opening door (unidirectional opening door), a second change is intended to increase the door opening range up to a range corresponding to the door so as to cover, in a direction from the front to the rear of a vehicle, a range corresponding to two rows of seats that are arranged in the front and in the rear in a vehicle body, and a third change is intended to realize a 2-step opening door that can perform a transition between three states which are a first door state in which the door is closed, a second door state in which the door is opened within a range corresponding to only the front seat 2 in the direction from front to rear, and a third door state in which the door is opened within a range corresponding to both the front seat 2 and the rear seat 3 in the direction from front to rear.

### Effects of the Invention

In the vehicle door device of the present invention, the second door state in which the door is opened within the range corresponding to only the front seat 2 in the direction from front to rear solves the problem that had occurred before. This problem stemmed from the fact that front a seat passenger's convenience which can be realized when a passenger easily and comfortably gets in the front seat or easily and comfortably gets out of the front seat, runs counter to the provision of a space that is required to be formed in a side surface of the vehicle body 1 so as to allow the passenger to easily and comfortably get in the front seat or to easily and comfortably descend from the front seat. Further, the third door state in which the door is opened within the range corresponding to both the front seat 2 and the rear seat 3 in the direction from front to rear allows a passenger to easily get in the rear seat and easily get out of the rear seat in a state in which another passenger is sitting in the front seat. Accordingly, the present invention can realize the comfort of the front seat 2 that is a requirement of coupe cars.

### BEST MODES FOR CARRYING OUT THE INVENTION

The present invention provides a 2-step swing style long front door opening vehicle door device. The basic construction of the vehicle door device according to the present invention includes a door 4, an opening 5, two first coupling units, a second coupling unit, an input unit 10 that allows a user to input manipulation signals for opening or closing the door 4, and a control unit 20. The control unit 20 controls the transition between three states which are a first door state in which the door is closed, a second door state in which the door is opened within a range corresponding to only the front seat 2 in a direction from front to rear, and a third door state in which the door is opened within a range corresponding to both the front seat 2 and the rear seat 3 in the direction from front to rear, in response to signals output from the input unit 10. Each of the two first coupling units is formed by a combination of a door lock solenoid 34a, 34b and a door lock pin 35a, 35b. The second coupling unit is formed by a combination of links 111, 211, 212, 311, 312, 411, 412 and rotation drive units 121, 122, 221, 222, 223, 321, 322, 323, 421, 422, 423. The input unit 10 may be formed using a remote control panel 10 as an example. The control unit 20 is formed using an input control unit 21, a memory unit 22 and an output control unit 23.

FIG. 1 is a table of models of a vehicle door device according to the present invention. 2-step swing style long front opening doors are divided into four classes that are classified according to the construction and operation of the second coupling unit. The four classes include a single link mechanism type 2-step swing style (Model-151) as will be described in embodiment 1, a double link mechanism (A) type 2-step swing style (Model-152) as will be described in embodiment 2, another double link mechanism (B) type 2-step swing style (Model-153) as will be described in embodiment 3, and a folding type 2-step swing style (Model-154) as will be described in embodiment 4. Further, FIGS. 2 through 7 are views illustrating the detailed operation of Model-1511a, 1511b, 1511c, 1511d, 1511e, 1511f and 1511g, Model-1512a, 1512b, 1512c, 1512d, 1512e, 1512f and 1512g, Model-1513a, 1513b, 1513c, 1513d, and Model-1514b, 1514c and 1514d, which are further classified according to the detailed operation of the four styles shown in FIG. 1. FIGS. 8 through 16 are views illustrating the construction of Model-1511c, Model-1512b, Model-1513a and Model-1514b which are representatives of the models shown in FIGS. 2 through 7. Further, FIG. 17 is a view illustrating the concept of Model-151b that is an example of a truss structure 6 in which the door 4 and the vehicle body 1 of embodiment 5 according to the present invention are integrated into a single structure. FIG. 18 is a view illustrating the appearance of a remote control panel 10 that is commonly used in Model-151. FIG. 19 is a view of the construction of a control system that is commonly used in Model-151. FIGS. 20 through 25 are flowcharts of the control unit that is commonly used in Model-151.

### Embodiment 1

Embodiment 1 relates to Model-1511. The second coupling unit of Model-1511 is formed using a single link mechanism that is fabricated using a link 111, a first rotation drive unit 121 and a second rotation drive unit 122. Hereinbelow, the operation of Model-1511a, 1511b, 1511c, 1511d, l 1511e, 1511f and 1511g will be described with reference to FIGS. 2 and 3. When Model-1511a is operated, the door 4 moves parallel to the vehicle side during both a transition from the first door state in which the door is closed to the second door state in which the door is opened within a range corresponding to only the front seat 2 in a direction from front to rear, and a transition from the second door state to the third door state in which the door is opened within a range corresponding to both the front seat 2 and the rear seat 3 in the direction from front to rear. When Model-1511b is operated, the door 4 moves in parallel during a transition from the first door state to the second door state, however, the door 4 is rotated during a transition from the second door state to the third door state. When Model-1511c is operated, the door 4 is rotated during a transition from the first door state to the second door state; however, the door 4 moves in parallel during a transition from the second door state to the third door state. When Model-1511d is operated, the door 4 is rotated during both a transition from the first door state to the second door state and a transition from the second door state to the third door state. When Model-1511e is operated, the door 4 moves in parallel during a transition from the first door state to the second door state, however, the door 4 is rotated in a direction opposite to the rotating direction of Model-1511b and is moved in parallel during a transition from the second door state to the third door state. When Model-1511f is operated, the door 4 is rotated in a direction opposite to the rotating direction of Model-1511b and is moved in parallel during a transition from the first door state to the second door state; however, the door 4 moves in parallel during a transition from the second door state to the third door state. When Model-1511g is operated, the door 4 is rotated in a direction opposite to the rotating direction of Model-1511b and is moved in parallel during a transition from the first door state to the second door state, and the door 4 is rotated in a direction opposite to the rotating direction of Model-1511b during a transition from the second door state to the third door state.

FIGS. 8 and 9 are views illustrating the construction of Model-1511c which is a representative of Model-1511. Here, FIG. 8(a) is a rear view of the first door state, FIG. 8(b) is a front view of the first door state, FIG. 9(a) is a plan view of the first door state, FIG. 9(b) is a plan view of the second door state, and FIG. 9(c) is a plan view of the third door state. Here, a vehicle body-side bracket 31 is installed in the opening 5 of the vehicle body 1, while a door-side bracket 32 is mounted to the door 4. The first coupling units include a door lock solenoid (front side) 34a, another door lock solenoid (rear side) 34b, a door lock pin (front side) 35a and another door lock pin (rear side) 35b, in which the two door lock pins are arranged in perpendicular to the two door lock solenoids, respectively. Here, the first coupling units couple or decouple the vehicle body-side bracket 31 to or from the door-side bracket 32 in the front and rear ends of the vehicle body-side bracket 31. The second coupling unit includes a link 111 (Model-1511), a first rotation drive unit 121 (Model-1511) and a second rotation drive unit 122 (Model-1511). Here, the first rotation drive unit 121 (Model-1511) couples a first end of the link 111 (Model-1511) to the rear end of the vehicle body-side bracket 31, while the second rotation drive unit 122 (Model-1511) couples a second end of the link 111 (Model-1511) to a center portion of the door-side bracket 32.

FIG. 18 is a view illustrating the appearance of the remote control panel 10 of Model-151. This remote control panel 10 can be manipulated by a user in a state in which the user grips a portion around a safety switch 11. In the remote control panel 10, there is an arrangement of two open switches 12, two open ½ switches 13 and two close switches 14 associated with left and right doors. Manipulation signals from a user are wirelessly transmitted from the remote control panel 10 to the control unit of the vehicle body 1. Here, another remote control panel having the same construction as that of the remote control panel 10 may be installed on a console box of the vehicle body 1.

FIG. 19 is a view illustrating the construction of a control system of Model-151. The control unit 20 includes the input control unit 21, the memory unit 22 and the output control unit 23. The input control unit 21 receives input signals from the remote control panel 10, a door position sensor (front side) 33a and a door position sensor (rear side) 33b, reads control programs output from the memory unit 22 and transmits the signals to an output device. The memory unit 22 stores therein the control programs and information about a present door state so as to perform a transition between three states that are the first door state, the second door state and the third door state associated with each of Model-1511, 1512, 1513, 1514. The output control unit 23 drives the door lock solenoid (front side) 34a, the door lock solenoid (rear side) 34b, the first rotation drive units 121, 221, 321 and 421, the second rotation drive units 122, 222, 322 and 422, and third rotation drive units 223, 323 and 423 using the control programs. Here, the difference between Model-1511 and the other models resides in that Model-1511 has no third rotation drive unit.

FIGS. 20 through 25 are flowcharts of processes of controlling Model-1511. FIG. 20 is a control flowchart of an operation by which the remote control panel 10 detects whether a switch has been manipulated or not. FIG. 21 is a flowchart of reading the control programs obtained from the memory unit 22 by the input control unit 21 so as to transit a present door state to a target door state. FIG. 22 is a flowchart of a subroutine corresponding to control programs that have been obtained from the input control unit 21 by the output control unit 23. FIG. 23 is a flowchart of a subroutine 12, 13 of controlling a transition from the first door state to the second door state or to the third door state. FIG. 24 is a flowchart of a subroutine 21, 31 of controlling the transition from the second or third door state to the first door state. FIG. 25 is a flowchart of a subroutine 23, 32 of controlling the transition from the second door state or from the third door state to the third door state or to the second door state. Here, the difference between Model-1511 and the other models resides in that Model-1511 does not perform a programmed driving operation performed by the third rotation drive unit for step S41, step S50 and step S60.

Hereinbelow, the process of controlling the transition of Model-1511c that is the representative of Model-1511 from the first door state in which the door is closed to the second door state in which the door is opened within the range corresponding to only the front seat 2 in the direction from front to rear will be described with reference to FIGS. 8, 9, 18 through 25. When the remote control panel 10 detects at step S10 that the safety switch 11 has been turned on and detects at step S13 that a left open ½ switch 13 has been turned on, the remote control panel 10 wirelessly outputs a left open ½ signal at step S14. At step S20, the input control unit 21 of the control unit 20 reads a parameter, X=1, representing that the door has been staying in the first to door state, from the memory unit 22. When the control unit 20 receives the left open ½ signal at step S22, the parameter becomes Y=2. Further, the control unit 20 reads a control program (XY=12) from the memory unit 22 at step S24, and outputs the control program (XY=12) to the output control unit 23 at step S25. When the output control unit 23 receives the control program (XY=12) at step S30 and detects at step 31 that the parameter of the control program is X=1, the output control unit 23 runs the subroutine (control 12, 13) and outputs a control process end signal to the input control unit 21 at step S34. At step S40 of the subroutine (control 12, 13), the output control unit 23 releases the door lock solenoid (front side) 34a, the door lock solenoid (rear side) 34b and the door lock solenoid (center) 34c. Thereafter, at step S41, the output control unit 23 drives both the first rotation drive unit 121 (Model-1511) and the second rotation drive unit 122 (Model-1511), thereby controlling the rotation angles based on the first door state so as to change the rotation angle of the first rotation drive unit 121 (Model-1511) from 0° to θ1a and to change the rotation angle of the second rotation drive unit 122 (Model-1511) from 0° to θ2a. Accordingly, the state of the door-side bracket 32 undergoes the transition from the first door state to the second door state in which the front side of the door-side bracket 32 has been rotated to be opened. When the input control unit 21 receives a control process end signal at step S26, the door state information parameter becomes X=2 representing the second door state at step S27.

Hereinbelow, the difference between the process of controlling the transition of Model-1511c from the second door state to the third door state in which the door is opened within the range corresponding to both the front seat 2 and the rear seat 3 in the direction from front to rear and the process of controlling the transition from the first door state to the second door state will be described. When the remote control panel 10 detects at step S11 that a left open switch 12 has been turned on, the remote control panel 10 wirelessly outputs a left open signal at step S12. At step S20, the input control unit 21 of the control unit 20 reads a parameter, X=2 representing that the door has been maintained in the second door state, from the memory unit 22. When the control unit receives the left open signal at step S23, the parameter becomes Y=3. Further, the control unit reads a control program (XY=23) from the memory unit 22 at step S24, and outputs the control program (XY=23) to the output control unit 23 at step S25. When the output control unit 23 receives the control program (XY=23) at step S30 and detects at step 31 that the parameters of the control program are X=2 and Y=3, the output control unit 23 performs the subroutine (control 23, 32). At step S60 of the subroutine (control 23, 32), the output control unit 23 drives both the first rotation drive unit 121 and the second rotation drive unit 122, thereby controlling the rotation angles based on the first door state so as to change the rotation angle of the first rotation drive unit 121 (Model-1511) from θ1a to θ1b and to change the rotation angle of the second rotation drive unit 122 (Model-1511) from θ2a to θ2b. Accordingly, the state of the door-side bracket 32 makes the transition from the second door state to the third door state, in which the door-side bracket 32 has moved backwards in parallel. When the input control unit 21 receives a control process end signal at step S26, the door state information parameter becomes X=3 representing the third door state at step S27.

Hereinbelow, the difference between the process of controlling the transition of Model-1511c from the third door state to the first door state and both the process of controlling the transition from the first door state to the second door state and the process of controlling the transition from the second door state to the third door state will be described. When the remote control panel 10 detects at step S15 that a left close switch 14 has been turned on, the remote control panel 10 wirelessly outputs a left close signal at step S16. At step S20, the input control unit 21 of the control unit 20 reads a parameter, X=3 representing that the door has been maintained in the third door state, from the memory unit 22. When the control unit receives the left close signal at step S21, the parameter becomes Y=1. Further, the control unit reads a control program (XY=31) from the memory unit 22 at step S24, and outputs the control program (XY=31) to the output control unit 23 at step S25. When the output control unit 23 receives the control program (XY=31) at step S30 and detects at step 32 that the parameter Y of the control program has the value of 1, the output control unit 23 executes the subroutine (control 21, 31). At step S50 of the subroutine (control 21, 31), the output control unit 23 drives both the first rotation drive unit 121 and the second rotation drive unit 122, thereby controlling the rotation angles so as to change the rotation angle of the first rotation drive unit 121 (Model-1511) from θ1b to 0° and to change the rotation angle of the second rotation drive unit 122 (Model-1511) from θ2b to 0°. Further, when the control unit detects input signals output from both the door position sensor (front side) 33a and the door position sensor (rear side) 33b at step S51, the door lock solenoid (front side) 34a, the door lock solenoid (rear side) 34b and the door lock solenoid (center) 34c are activated at step S52, so that the state of the door-side bracket 32 is changed to the first door state in which the door-side bracket 32 has been closed. When the input control unit 21 receives a control process end signal at step S26, the door state information parameter becomes X=1 representing the first door state at step S27.

The processes of controlling Model-1511a, 1511b, 1511d, 1511e, 1511f and 1511g which are the other models of Model-1511 remain the same as that of Model-1511c, but the values of θ1a, θ2a, θ1b and θ2b are different from the values of Model-1511c.

### Embodiment 2

Embodiment 2 relates to Model-1512. The second coupling unit of Model-1512 is formed using a double link mechanism (A), which is illustrated in the table of FIG. 1 and is fabricated using a first link 211 (Model-1512), a second link 212 (Model-1512), a first rotation drive unit 221 (Model-1512), a second rotation drive unit 222 (Model-1512) and a third rotation drive unit 223 (Model-1512). When compared to Model-1511, Model-1512 is advantageous in that the position of the door 4 in the second door state or in the third door state approaches more closely to the vehicle body 1 so that it is possible to reduce the size of the space that is formed in the side surface of the vehicle body 1 so as to allow the door 4 to be opened or closed. FIG. 4 illustrates the operations of Model-1512a, 1512b, 1512c and 1512d. FIG. 5 illustrates the operations of Model-1512e, 1512f and 1512g. Here, the basic operations of the transition of the door state in Model-1512a, 1512b, 1512c, 1512d, 1512e, 1512f and 1512g remain the same as those of Model-1511a, 1511b, 1511c, 1511d, 1511e, 1511f and 1511g, respectively. Hereinbelow, the difference between Model-1512 of embodiment 2 and Model-1511 of embodiment 1 will be described.

FIGS. 10 and 11 are views illustrating the construction of Model-1512b that is the representative of Model-1512, in which FIG. 10(a) is a rear view of the first door state, FIG. 10(b) is a front view of the first door state, FIG. 11(a) is a plan view of the first door state, FIG. 11(b) is a plan view of the second door state and FIG. 11(c) is a plan view of the third door state. The second coupling unit of Model-1512 is formed using a first link 211 (Model-1512), a second link 212 (Model-1512), a first rotation drive unit 221 (Model-1512), a second rotation drive unit 222 (Model-1512) and a third rotation drive unit 223 (Model-1512). Here, the first rotation drive unit 221 (Model-1512) couples a first end of the first link 211 (Model-1512) to the rear end of the vehicle body-side bracket 31, the second rotation drive unit 222 (Model-1512) couples a second end of the first link 211 (Model-1512) to a first end of a second link 212 (Model-1512), and the third rotation drive unit 223 (Model-1512) couples a second end of the second link 212 (Model-1512) to a center portion of the door-side bracket 32.

Hereinbelow, the process of controlling the transition from the first door state to the second door state of Model-1512b that is the representative of Model-1512 will be described with reference to FIGS. 10, 11 and 18 through 25. At step S40 of the subroutine (control 12, 13), the output control unit 23 releases the door lock solenoid (front side) 34a, the door lock solenoid (rear side) 34b and the door lock solenoid (center) 34c, and drives the first rotation drive unit 221, the second rotation drive unit 222, the third rotation drive unit 223 at step S41, thereby controlling the rotation angles based on the first door state in such a way that the rotation angle of the first rotation drive unit 221 (Model-1512) is changed from 0° to θ1a and the rotation angle of the second rotation drive unit 222 (Model-1512) is changed from 0° to θ2a. Accordingly, the state of the door-side bracket 32 is changed from the first door state to the second door state in which the door-side bracket 32 has moved backwards in parallel. In the above state, the third rotation drive unit 223 (Model-1512) does not rotate.

Next, the process of controlling the transition from the second door state to the third door state of Model-1512b will be described. At step S60 of the subroutine (control 23, 32), the output control unit 23 drives the first rotation drive unit 221, the second rotation drive unit 222 and the third rotation drive unit 223, thereby controlling the rotation angles based on the first door state in such a way that the rotation angle of the first rotation drive unit 221 (Model-1512) is changed from θ1a to θ1b, the rotation angle of the second rotation drive unit 222 (Model-1512) is changed from θ2a to θ2b, and the rotation angle of the third rotation drive unit 223 (Model-1512) is changed from 0° to θ3b. Accordingly, the state of the door-side bracket 32 is changed from the second door state to the third door state in which the front side of the bracket 32 is fully open.

Next, the process of controlling the transition from the third door state to the first door state of Model-1512b will be described. At step S50 of the subroutine (control 21, 31), the output control unit 23 drives the first rotation drive unit 221, the second rotation drive unit 222 and the third rotation drive unit 223, thereby controlling the rotation angles based on the first door state in such a way that the rotation angle of the first rotation drive unit 221 (Model-1512) is changed from θ1b to 0°, the rotation angle of the second rotation drive unit 222 (Model-1512) is changed from θ2b to 0°, and the rotation angle of the third rotation drive unit 223 (Model-1512) is changed from θ3b to 0. Accordingly, the state of the door-side bracket 32 is changed from the third door state to the first door state in which the door-side bracket 32 has been closed.

FIG. 12 illustrates the construction of a four-seater coupe car having a vehicle door device of Model-1512b in schematic views, in which FIG. 12(a) is a plan view of the first door state, FIG. 12(b) is a plan view of the second door state, FIG. 12(c) is a plan view of the third door state, and FIG. 12(d) is a front view of the first door state. The transition from the first door state to the second door state is realized by a parallel movement, and the space that is required near the side surface of the vehicle body 1 so as to allow the door 4 to be opened or closed during this transition is small. Further, the transition from the second door state to the third door state is realized by a rotation and no space is required in the rear part of the vehicle body 1 during this transition.

The processes of controlling Model-1512a, 1512b, 1512d, 1512e, 1512f and 1512g which are the other models of Model-1512 remain the same as that of Model-1512c, but the values of θ1a, θ2a, θ3a, θ1b, θ2b, θ3b are different from the values of Model-1512c.

### Embodiment 3

Embodiment 3 relates to Model-1513. The second coupling unit of Model-1513 is a double link mechanism (B) illustrated in the table of FIG. 1 and is fabricated using a first link 311 (Model-1513), a second link 312 (Model-1513), a first rotation drive unit 321 (Model-1513), a second rotation drive unit 322 (Model-1513) and a third rotation drive unit 323 (Model-1513). In both the second door state and the third door state of Model-1513, the location of the door 4 can approach the vehicle body 1 in the same manner as that described in Model-1512, so that Model-1513 can reduce the size of the space that is defined in the side surface of the vehicle body 1 so as to allow the door 4 to be opened or closed. FIG. 6 illustrates operations of Model-1513a, 1513b, 1513c and 1513d. Here, the basic operations of the transition of the door state in Model-1513a, 1513b, 1513c and 1513d remain the same as those of Model-1511a, 1511b, 1511c and 1511d, and as those of Model-1512a, 1512b, 1512c and 1512d, respectively. In Model-1513, Model-1513e, 1513f or 1513g do not really exist. Hereinbelow, the difference between Model-1513 of embodiment 3, Model-1511 of embodiment 1 and Model-1512 of embodiment 2 will be described.

FIGS. 13 and 14 are views illustrating the construction of Model-1513a that is the representative of Model-1513, in which FIG. 13(a) is a rear view of the first door state, FIG. 13(b) is a front view of the first door state, FIG. 14(a) is a plan view of the first door state, FIG. 14(b) is a plan view of the second door state and FIG. 14(c) is a plan view of the third door state. In the same manner as that described in Model-1512, the second coupling unit of Model-1513 is formed using a first link 311 (Model-1513), a second link 312 (Model-1513), a first rotation drive unit 321 (Model-1513), a second rotation drive unit 322 (Model-1513) and a third rotation drive unit 323 (Model-1513). The first rotation drive unit 321 (Model-1513) couples a first end of the first link 311 (Model-1513) to the rear end of the vehicle body-side bracket 31, the second rotation drive unit 322 (Model-1513) couples a second end of the first link 311 (Model-1513) to a first end of the second link 312 (Model-1513), and the third rotation drive unit 323 (Model-1513) couples a second end of the second link 312 (Model-1513) to the center portion of the door-side bracket 32.

There are two deferent points between Model-1513 and Model-1512. The first different point is an operational difference. Described in detail, unlike Model-1512 in which the transition from the first door state to the second door state is driven mainly by the first rotation drive unit 221 (Model-1512), the transition of Model-1513 from the first door state to the second door state is driven mainly by the second rotation drive unit 322 (Model-1513). In Model-1513, there is no operation of Model-1513e, 1513f or 1513g. The second different point is a structural difference. Described in detail, unlike Model-1512 in which the first link 211 (Model-1512) is longer than the second link 212 (Model-1512), the first link 311 (Model-1513) of Model-1513 is shorter than the second link 312 (Model-1513).

Hereinbelow, the process of controlling the transition from the first door state to the second door state of Model-1513a that is the representative of Model-1513 will be described with reference to FIGS. 13, 14, 18 through 25. At step S40 of the subroutine (control 12, 13), the output control unit 23 releases the door lock solenoid (front side) 34a, the door lock solenoid (rear side) 34b and the door lock solenoid (center) 34c and, at step S41, drives the first rotation drive unit 321 (Model-1513), the second rotation drive unit 322 (Model-1513) and the third rotation drive unit 323 (Model-1513), thereby controlling the rotation angles based on the first door state in such a way that the rotation angle of the first rotation drive unit 321 (Model-1513) is changed from 0° to θ1a, the rotation angle of the second rotation drive unit 322 (Model-1513) is changed from 0° to θ2a, and the rotation angle of the third rotation drive unit 323 (Model-1513) is changed from 0° to θ3a. Accordingly, the state of the door-side bracket 32 is changed from the first door state to the second door state in which the door-side bracket 32 has moved backwards in parallel.

Next, the process of controlling the transition from the second door state to the third door state of Model-1513a will be described. Here, at step S60 of the subroutine (control 23, 32), the output control unit 23 drives the first rotation drive unit 321 (Model-1513), the second rotation drive unit 322 (Model-1513) and the third rotation drive unit 323 (Model-1513), thereby controlling the rotation angles based on the first door state in such a way that the rotation angle of the first rotation drive unit 321 (Model-1513) is changed from θ1a to θ1b, the rotation angle of the second rotation drive unit 322 (Model-1513) is changed from θ2a to 0°, and the rotation angle of the third rotation drive unit 323 (Model-1513) is changed from θ3a to θ3b (=θ3a). Accordingly, the state of the door-side bracket 32 is changed from the second door state to the third door state in which the door-side bracket 32 has further moved backwards in parallel.

Next, the process of controlling the transition from the third door state to the first door state of Model-1513a will be described. At step S50 of the subroutine (control 21, 31), the output control unit 23 drives the first rotation drive unit 321 (Model-1513), the second rotation drive unit 322 (Model-1513) and the third rotation drive unit 323 (Model-1513), thereby controlling the rotation angles based on the first door state in such a way that the rotation angle of the first rotation drive unit 321 (Model-1513) is changed from θ1b to 0°, the rotation angle of the second rotation drive unit 322 (Model-1513) is changed from θ2b to 0°, and the rotation angle of the third rotation drive unit 323 (Model-1513) is changed from θ3b to 0°. Accordingly, the state of the door-side bracket 32 is changed from the third door state to the first door state in which the door-side bracket 32 has been closed.

The processes of controlling Model-1513b, 1513c and 1513d which are the other models of Model-1513 remain the same as that of Model-1513a, but the values of θ1a, θ2a, θ3a, θ1b, θ2b and θ3b are different from the values of Model-1513a.

### Embodiment 4

Embodiment 4 relates to Model-1514. The second coupling unit of Model-1514 is a folding link mechanism illustrated in the table of FIG. 1 and is formed using a first link 411 (Model-1514), a second link 412 (Model-1514), a first rotation drive unit 421 (Model-1514), a second rotation drive unit 422 (Model-1514) and a third rotation drive unit 423 (Model-1514). In the same manner as those described in Model-1512 and Model-1513, Model-1514 is advantageous in that the position of the door 4 in the second door state and in the third door state approaches the vehicle body 1 so that it is possible to reduce the size of the space that is formed in the side surface of the vehicle body 1 so as to allow the door 4 to be opened or closed. FIG. 7 illustrates the operations of Model-1514b, 1514c and 1514d. Here, the basic operations of the transition of the door state in Model-1514b, 1514c and 1514d remain the same as those of Model-1511b, 1511c and 1511d, and as those of Model-1512b, 1512c and 1512d, and as those of Model-1513b, 1513c and 1513d, respectively. In Model-1514, Model-1514a, 1514e, 1514f or 1514g do not actually exist. Hereinbelow, the difference between Model-1514 of embodiment 4, Model-1511 of embodiment 1, Model-1512 of embodiment 2 and Model-1513 of embodiment 3 will be described.

FIGS. 15 and 16 illustrate the construction of Model-1514b that is the representative of Model-1514 in schematic views, in which FIG. 15(a) is a rear view of the first door state, FIG. 15(b) is a front view of the first door state, FIG. 16(a) is a plan view of the first door state, FIG. 16(b) is a plan view of the second door state, and FIG. 16(c) is a plan view of the third door state. The second coupling unit of Model-1514 is fabricated using a first link 411 (Model-1514), a second link 412 (Model-1514), a first rotation drive unit 421 (Model-1514), a second rotation drive unit 422 (Model-1514) and a third rotation drive unit 423 (Model-1514). Here, the first rotation drive unit 421 (Model-1514) couples a first end of the first link 411 (Model-1514) to the rear end of the vehicle body-side bracket 31, the second rotation drive unit 422 (Model-1514) couples a second end of the first link 411 (Model-1514) to a first end of the second link 412 (Model-1514), and the third rotation drive unit 423 (Model-1514) couples a second end of the second link 412 (Model-1514) to the rear end of the door-side bracket 32. In the first door state, the first link 411 (Model-1514) and the second link 412 (Model-1514) are folded on each other and are placed in parallel at a location near the door-side bracket 32.

The second coupling unit of Model-1514 is different from the second coupling unit of Model-1512 or of Model-1513. In Model-1512 and Model-1513, the respective second links 212 (Model-1512) and 312 (Model-1513) are connected to the center portion of the door-side bracket 32. Further, in the first door state of Model-1512 and Model-1513, the first link 211 (Model-1512) and the second link 212 (Model-1512) are opened, and the first link 311 (Model-1513) and the second link 312 (Model-1513) are opened so that the first and second links of each of Model-1512 and Model-1513 are placed in parallel at a location near the door-side bracket 32. However, in Model-1514, the second link 412 (Model-1514) is coupled to the rear end of the door-side bracket 32 and, in the first door state, the first link 411 (Model-1514) and the second link 412 (Model-1514) are folded on each other and are placed in parallel at a location near the door-side bracket 32.

Hereinbelow, the process of controlling the transition from the first door state to the second door state of Model-1514b that is the representative of Model-1514 will be described with reference to FIGS. 15, 16, 18 through 25. At step S40 of the subroutine (control 12, 13), the output control unit 23 releases the door lock solenoid (front side) 34a, the door lock solenoid (rear side) 34b and the door lock solenoid (center) 34c and, at step S41, drives the first rotation drive unit 421 (Model-1514), the second rotation drive unit 422 (Model-1514) and the third rotation drive unit 423 (Model-1514), thereby controlling the rotation angles based on the first door state in such a way that the rotation angle of the first rotation drive unit 421 (Model-1514) is changed from 0° to θ1a, and the rotation angle of the second rotation drive unit 422 (Model-1514) is changed from 0° to θ2a. Accordingly, the state of the door-side bracket 32 is changed from the first door state to the second door state in which the door-side bracket 32 has moved backwards in parallel.

Next, the process of controlling the transition from the second door state to the third door state of Model-1514b will be described based on a difference between the processes of controlling the transition from the second door state to the third door state and the transition from the first door state to the second door state. At step S60 of the subroutine (control 23, 32), the output control unit 23 drives the first rotation drive unit 421 (Model-1514), the second rotation drive unit 422 (Model-1514) and the third rotation drive unit 223, thereby controlling the rotation angles based on the first door state in such a way that the rotation angle of the first rotation drive unit 421 (Model-1514) is changed from θ1a to θ1b (=θ1a), the rotation angle of the second rotation drive unit 422 (Model-1514) is changed from θ2a to θ2b(=θ2a), and the rotation angle of the third rotation drive unit 423 (Model-1514) is changed from 0° to θ3b. Accordingly, the state of the door-side bracket 32 is changed from the second door state to the third door state in which the door-side bracket 32 has been rotated.

Next, the process of controlling the transition from the third door state to the first door state of Model-1514b will be described based on a difference between the processes of controlling the transition from the third door state to the first door state and the transition from the first door state to the second door state. At step S50 of the subroutine (control 21, 31), the output control unit 23 drives the first rotation drive unit 421 (Model-1514), the second rotation drive unit 422 (Model-1514) and the third rotation drive unit 423 (Model-1514), thereby controlling the rotation angles based on the first door state in such a way that the rotation angle of the first rotation drive unit 421 (Model-1514) is changed from θ1b to 0°, the rotation angle of the second rotation drive unit 422 (Model-1514) is changed from θ2b to 0°, and the rotation angle of the third rotation drive unit 423 (Model-1514) is changed from θ3b to 0°. Accordingly, the state of the door-side bracket 32 is changed from the third door state to the first door state in which the door-side bracket 32 has been closed.

The processes of controlling Model-1514c and 1514d which are the other models of Model-1514 remain the same as that of Model-1514b, but the values of θ1a, θ2a, θ3a, θ1b, θ2b and θ3b are different from the values of Model-1514b.

### Embodiment 5

Embodiment 5 relates to a truss structure 6 that is formed in the opening 5 of the vehicle body 1 having the 2-step swing style long front opening door (Model-151) according to the present invention. FIG. 17 illustrates the truss structure 6 as an example of Model-1512. Here, the vehicle body-side bracket 31 and the door-side bracket 32 form an integrated structure, in which the front-side first coupling unit that is formed using both the door lock solenoid (front side) 34a and the door lock pin (front side) 35a, the rear-side first coupling unit that is formed using both the door lock solenoid (rear side) 34b and the door lock pin (rear side) 35b, and the third coupling unit that is formed using both the door lock solenoid (center) 34c and the door lock pin (center) 35c are integrated with each other. Accordingly, the first rotation drive unit 221 (Model-1512) that forms the second coupling unit is free from stress caused by deformation of the vehicle body 1.

### INDUSTRIAL APPLICABILITY

Particularly, the vehicle door device of the present invention can be preferably used in a cabriolet car and in a small hatchback car in addition to the coupe car. In the cabriolet car, due to the large surface area of a door opening, a passenger can easily get in and easily get out of the rear seat and, because the door forms a part of the structure of a vehicle body, a highly rigid and light vehicle body can be realized. Further, in the small hatchback car, due to the large surface area of the door opening, a variety of goods can be easily loaded in the vehicle through the side of the vehicle body.

### BRIEF DESCRIPTION OF THE DRAWINGS

FIG. 1 is a table of models of a long front opening vehicle door device (2-step swing style);

FIG. 2 illustrates the operations of Model-1511a, 1511b, 1511c and 1511d in respective views;

FIG. 3 illustrates the operations of Model-1511e, 1511f and 1511g in respective views;

FIG. 4 illustrates the operations of Model-1512a, 1512b, 1512c and 1512d in respective views;

FIG. 5 illustrates the operations of Model-1512e, 1512f and 1512g in respective views;

FIG. 6 illustrates the operations of Model-1513a, 1513b, 1513c and 1513d in respective views;

FIG. 7 illustrates the operations of Model-1514b, 1514c and 1514d in respective views;

FIG. 8 illustrates the construction of Model-1511c in first views;

FIG. 9 illustrates the construction of Model-1511c in second views;

FIG. 10 illustrates the construction of Model-1512b in first views;

FIG. 11 illustrates the construction of Model-1512b in second views;

FIG. 12 illustrates the construction of a four-seater coupe vehicle having a vehicle door device of Model-1512b in schematic views;

FIG. 13 illustrates the construction of Model-1513a in first views;

FIG. 14 illustrates the construction of Model-1513a in second views;

FIG. 15 illustrates the construction of Model-1514b in first views;

FIG. 16 illustrates the construction of Model-1514b in second views;

FIG. 17 is a view illustrating the concept of a truss construction of Model-151 (Model-1512);

FIG. 18 is a view illustrating the appearance of a remote control panel of Model-151;

FIG. 19 is a view illustrating the construction of a control system of Model-151;

FIG. 20 is a flowchart of the remote control panel of Model-151;

FIG. 21 is a flowchart of an input control unit of Model-151;

FIG. 22 is a flowchart of an output control unit of Model-151;

FIG. 23 is a flowchart of control programs (12, 13) of Model-151;

FIG. 24 is a flowchart of control programs (21, 31) of Model-151; and

FIG. 25 is a flowchart of control programs (23, 32) of Model-151.

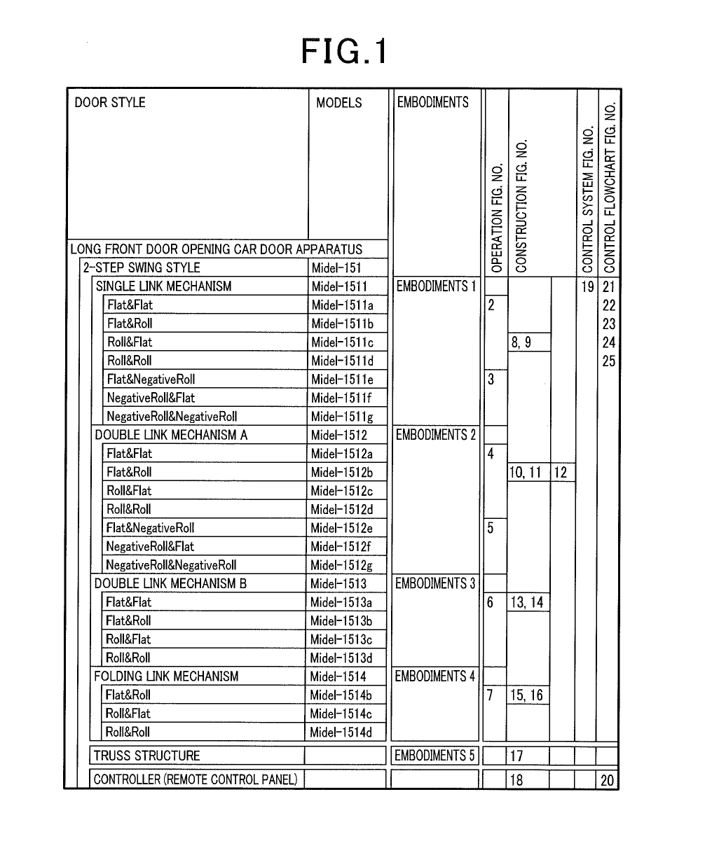

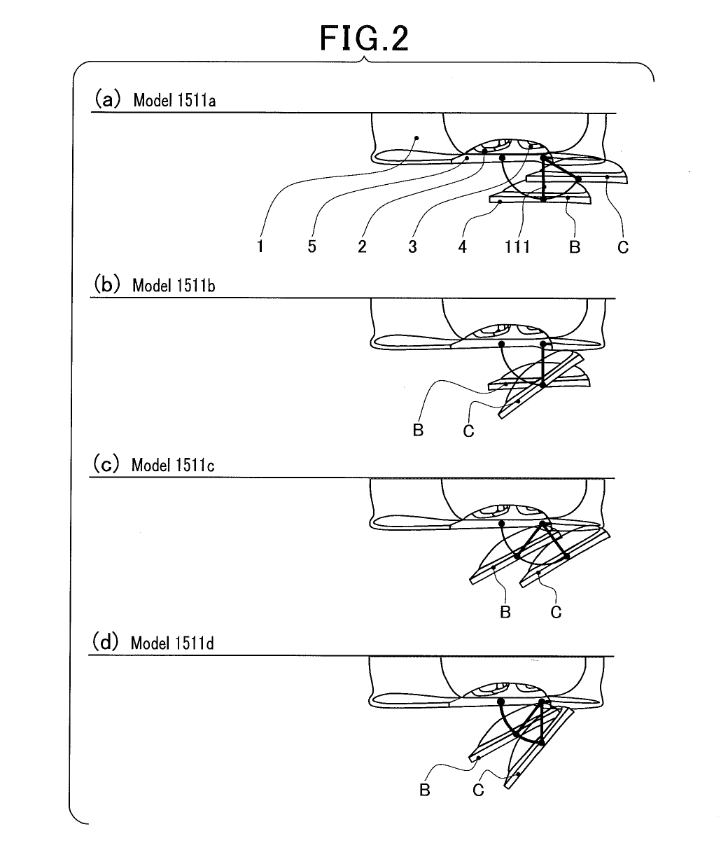

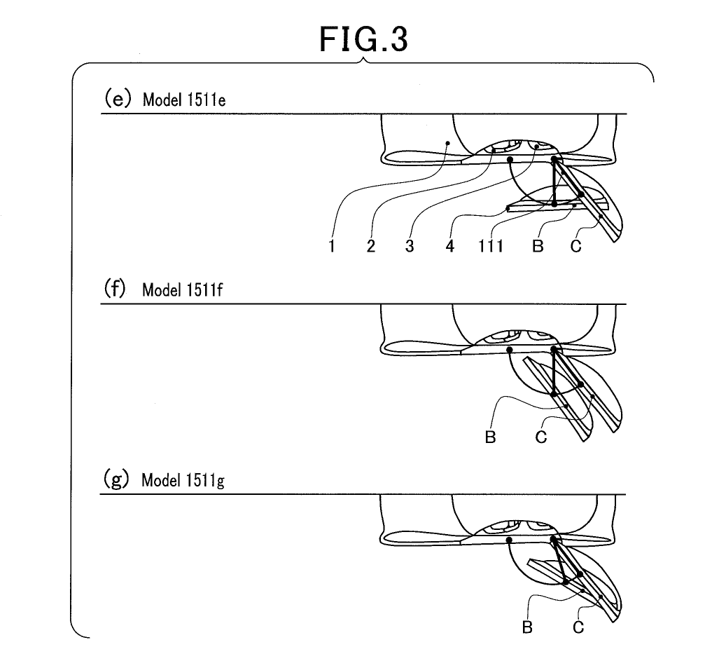

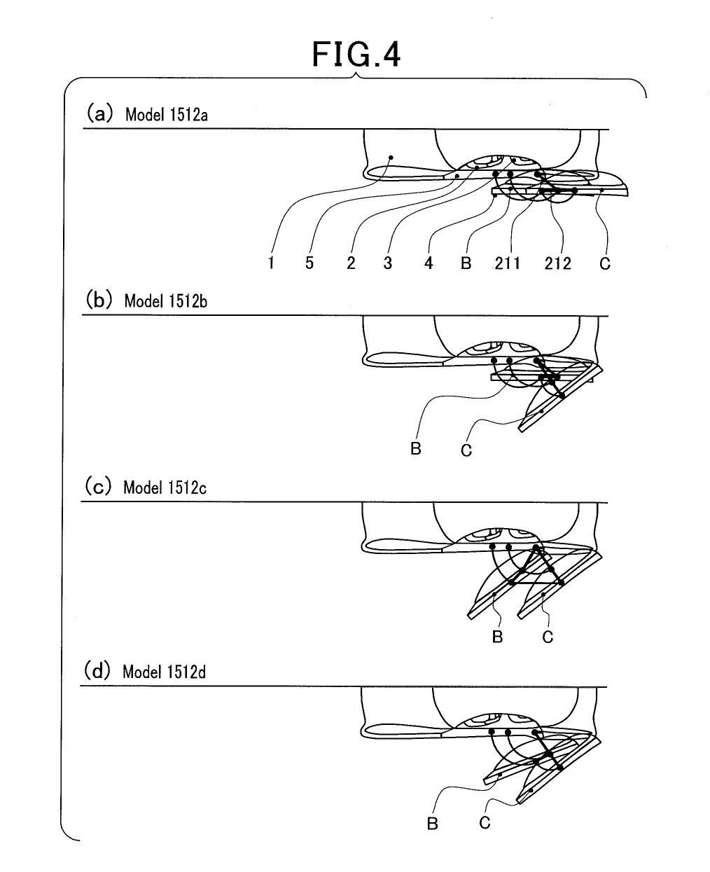

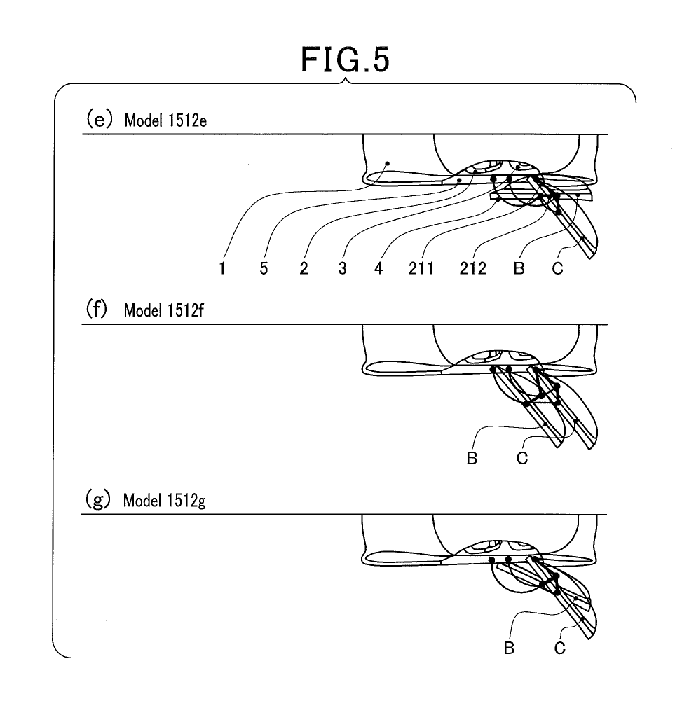

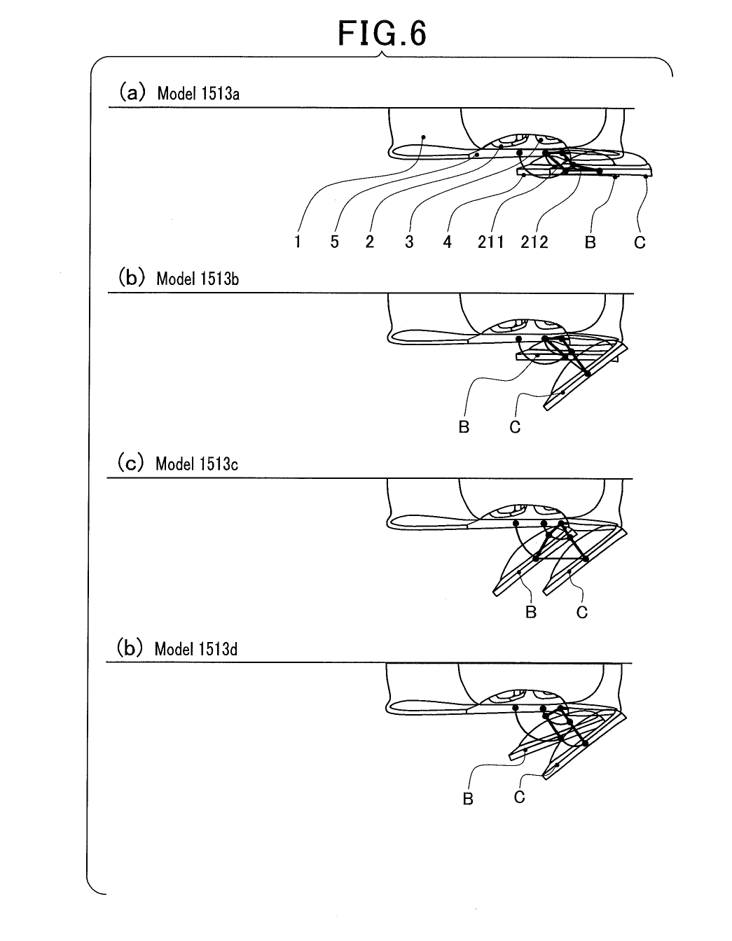

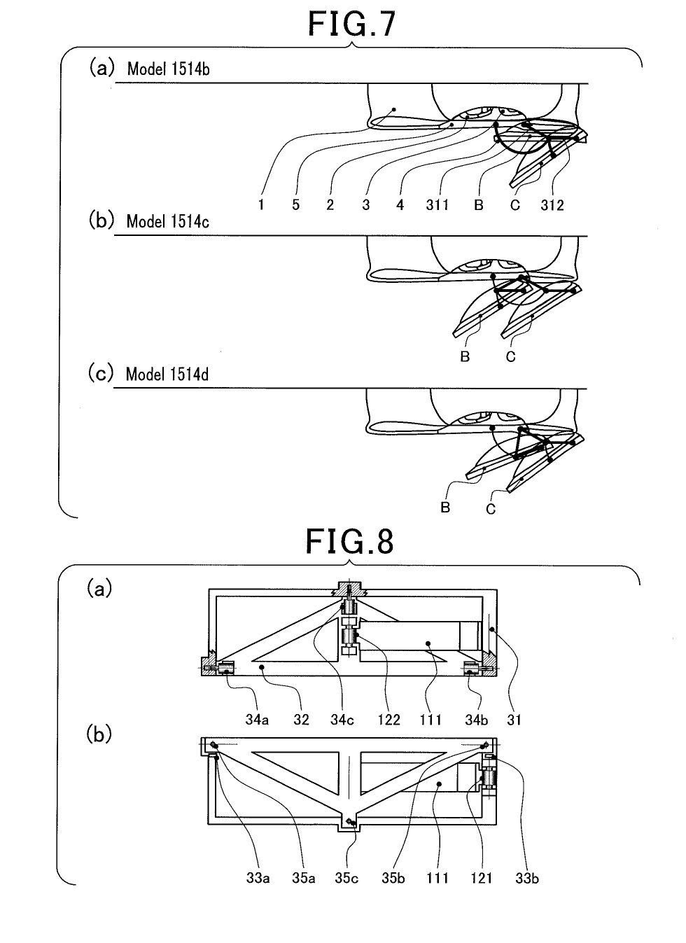

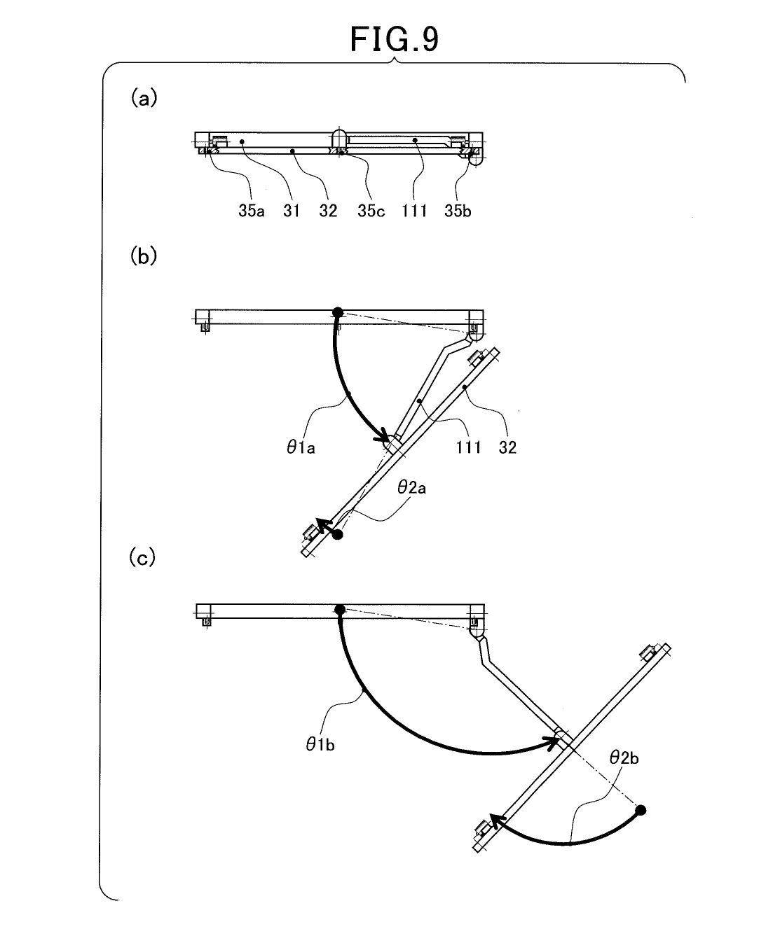

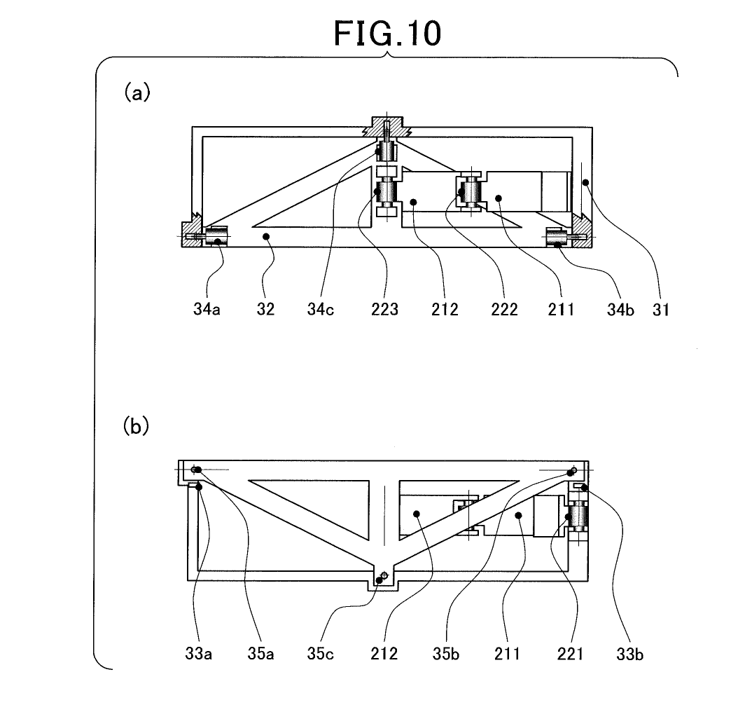

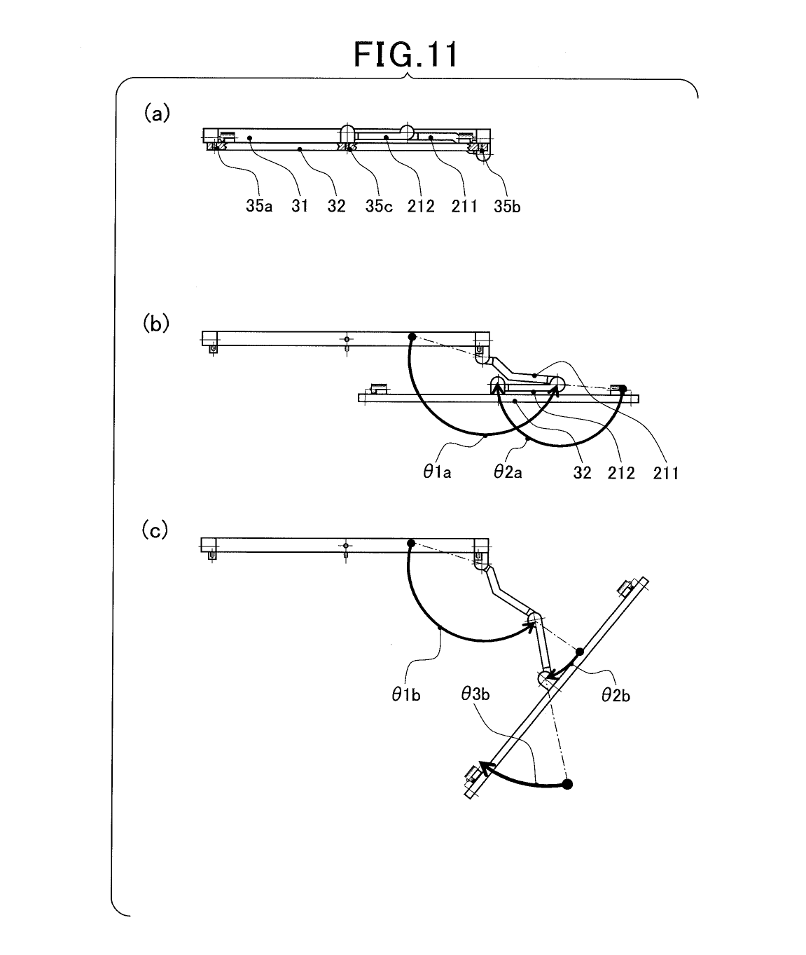

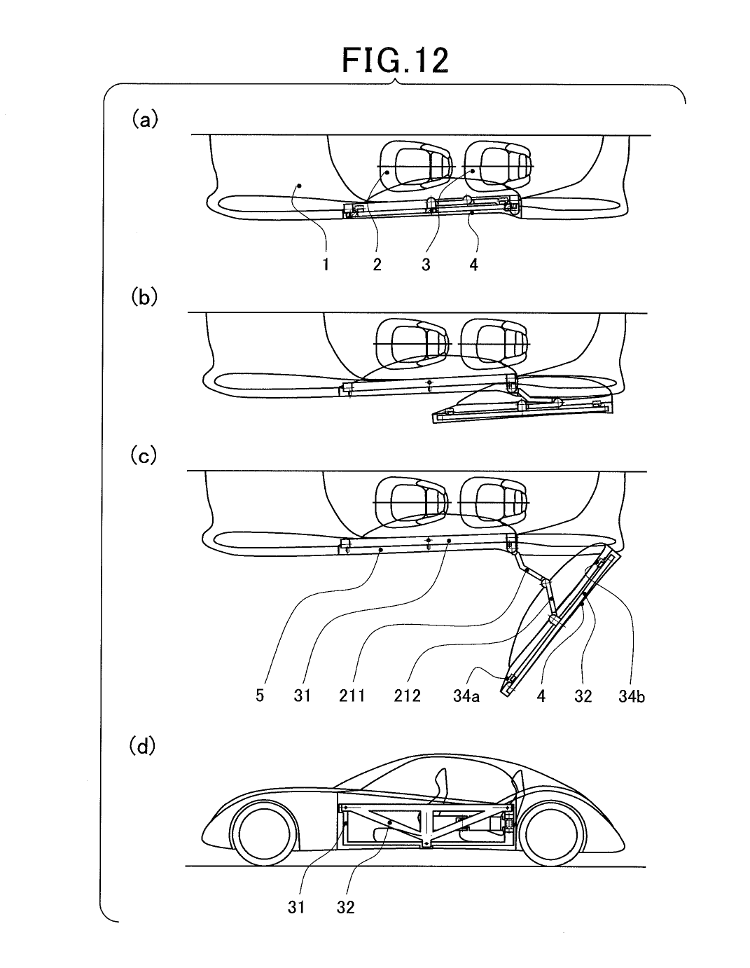

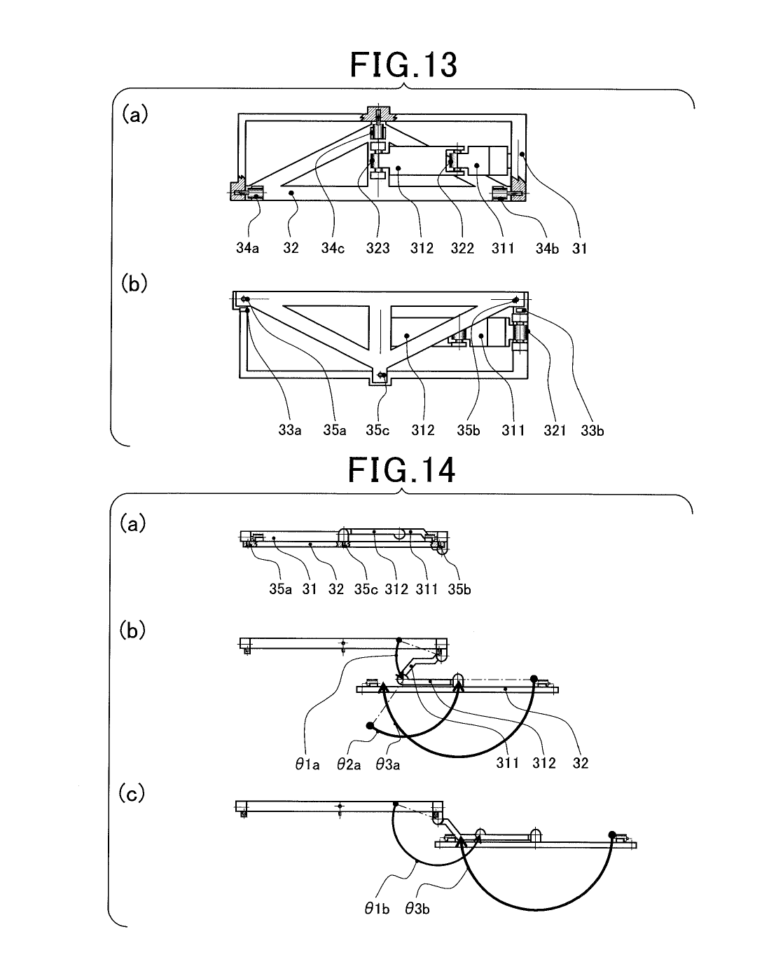

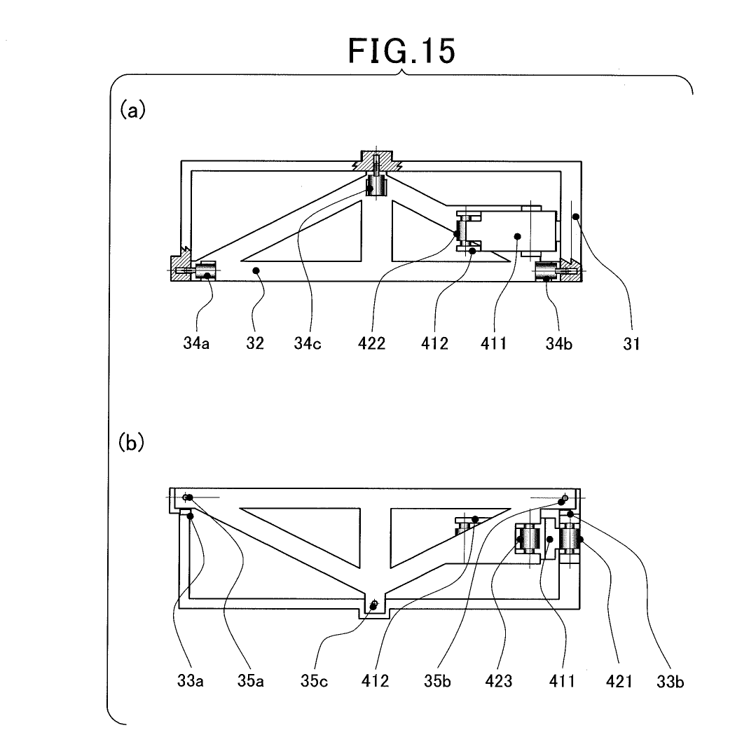

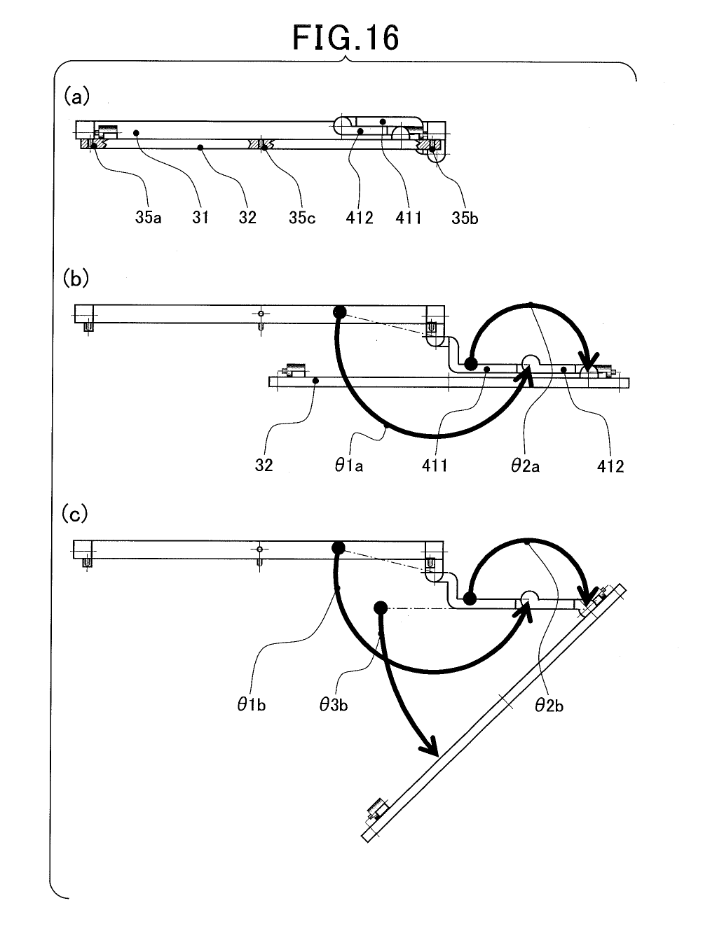

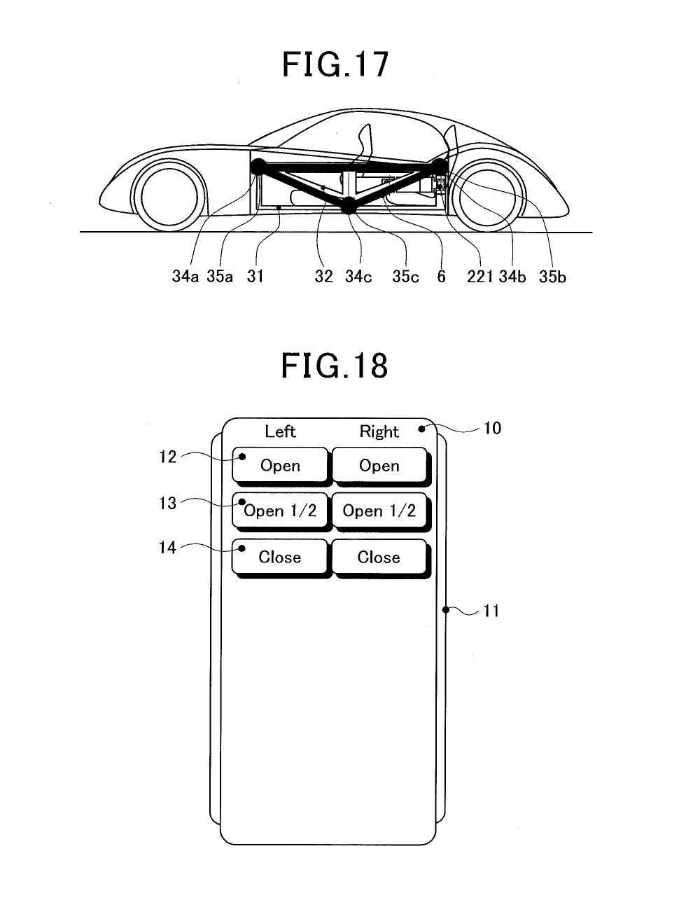

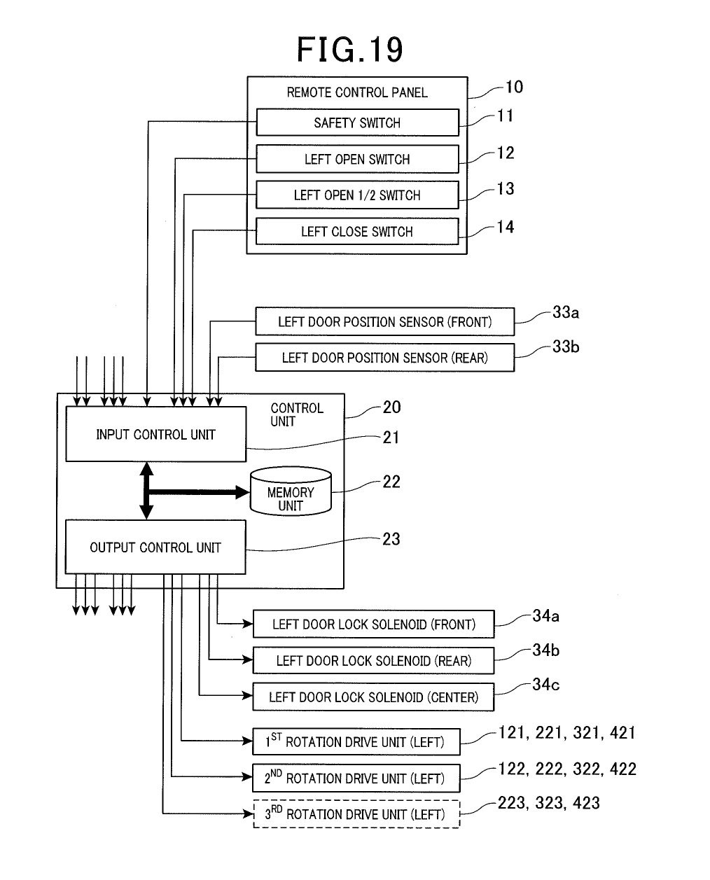

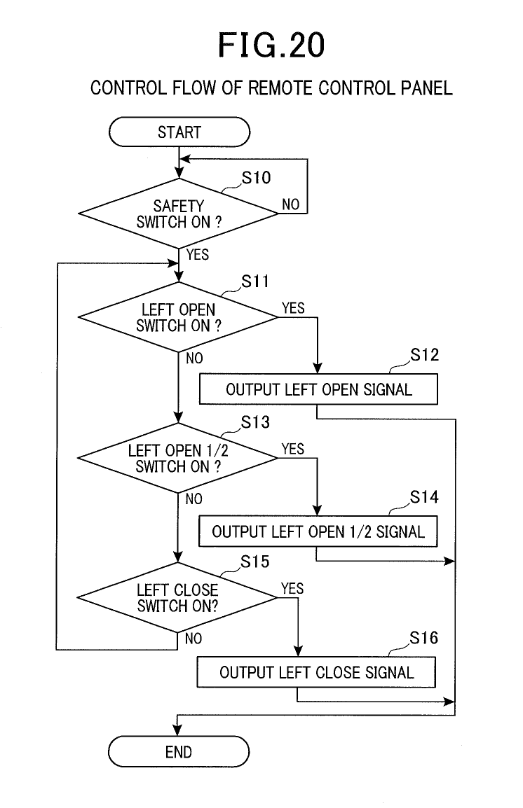

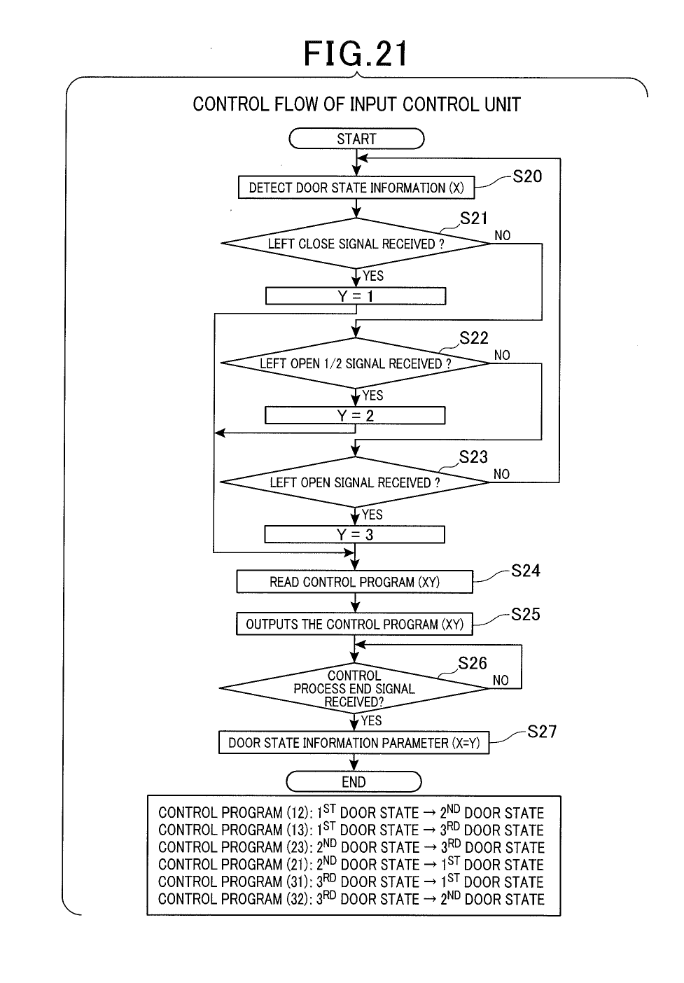

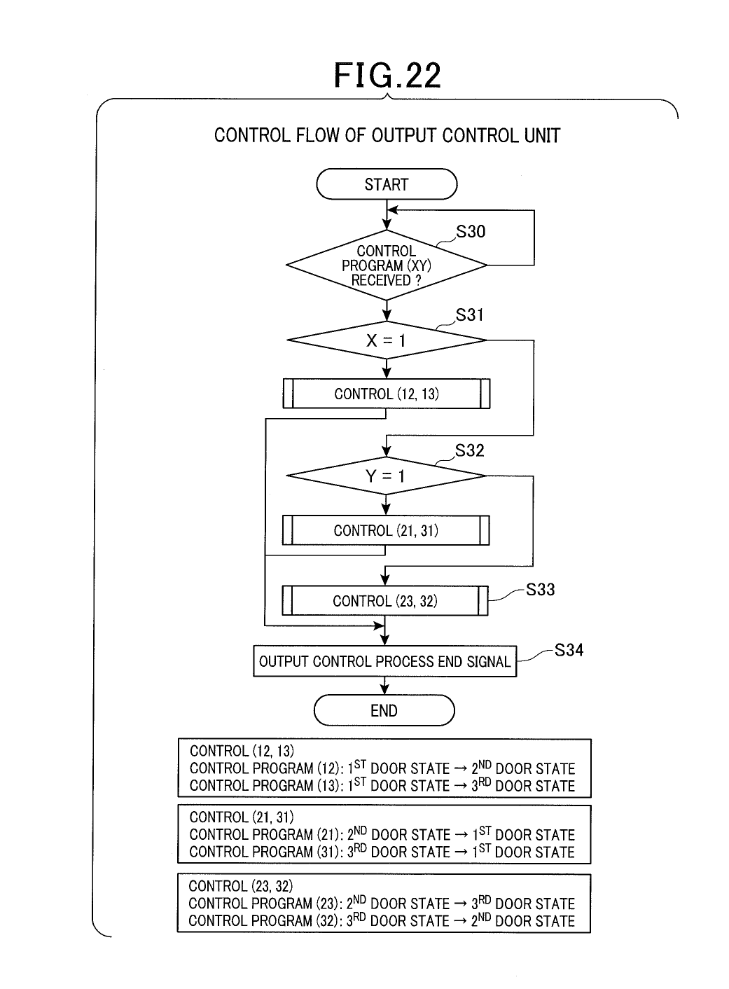

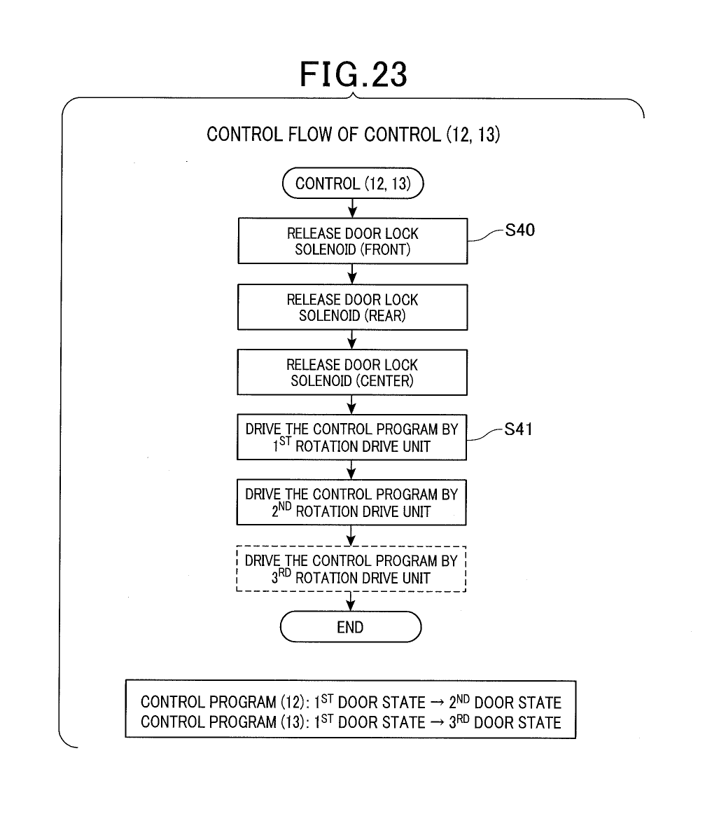

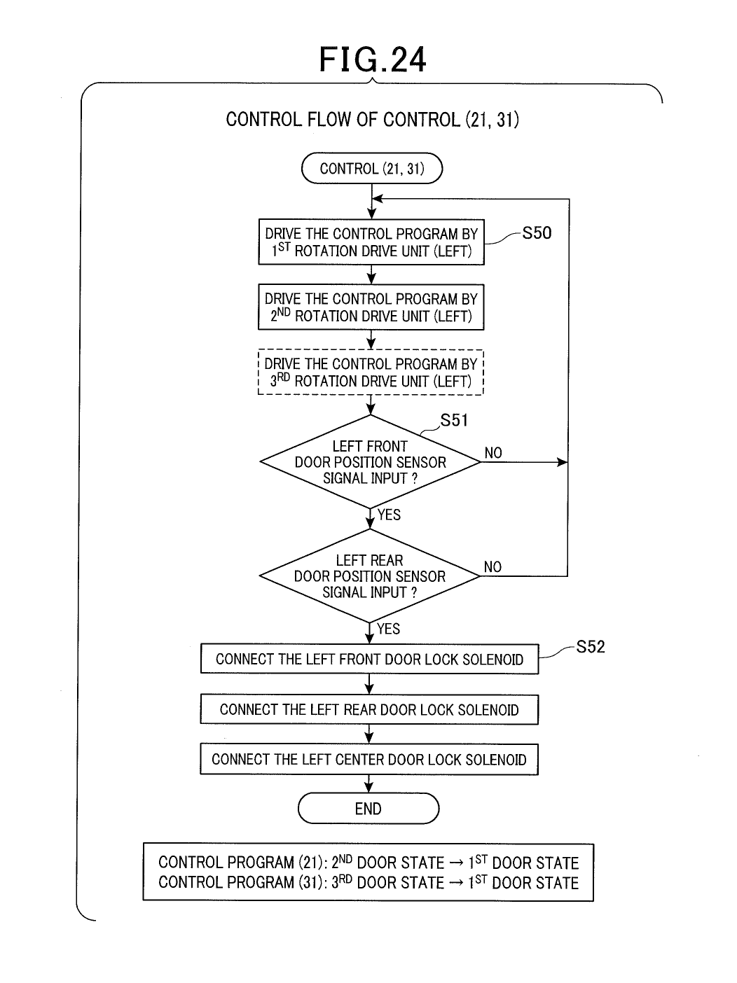

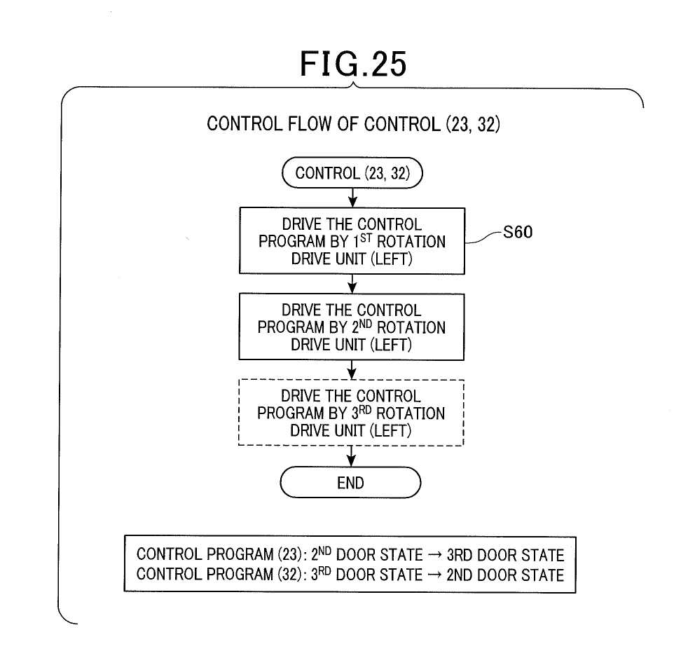

DESCRIPTION OF THE ELEMENTS IN THE DRAWINGS

| | | |
|---|---|---|
| 1: | vehicle body | 2: front seat |
| 3: | rear seat | 4: door |
| 5: | opening | 6: truss structure |
| 10: | remote control panel | 11: safety switch |
| 12: | open switch | 13: open ½ switch |
| 14: | close switch | 20: control unit |
| 21: | input control unit | 22: memory unit |
| 23: | output control unit | 31: vehicle body-side bracket |

| | |
|---|---|
| 32: | door-side bracket |
| 33a: | door position sensor (front side) |
| 33b: | door position sensor (rear side) |
| 34a: | door lock solenoid (front side) |
| 34b: | door lock solenoid (rear side) |
| 34c: | door lock solenoid (center) |
| 35a: | door lock pin (front side) |
| 35b: | door lock pin (rear side) |
| 35c: | door lock pin (center) |
| 111: | link (Model-1511) |
| 121: | first rotation drive unit (Model-1511) |
| 122: | second rotation drive unit (Model-1511) |
| 211: | first link (Model-1512) |
| 212: | second link (Model-1512) |
| 221: | first rotation drive unit (Model-1512) |
| 222: | second rotation drive unit (Model-1512) |
| 223: | third rotation drive unit (Model-1512) |
| 311: | first link (Model-1513) |
| 312: | second link (Model-1513) |
| 321: | first rotation drive unit (Model-1513) |
| 322: | second rotation drive unit (Model-1513) |
| 323: | third rotation drive unit (Model-1513) |
| 411: | first link (Model-1514) |
| 412: | second link (Model-1514) |
| 421: | first rotation drive unit (Model-1514) |
| 422: | second rotation drive unit (Model-1514) |
| 423: | third rotation drive unit (Model-1514) |

1. A vehicle door device comprising:
a door (4) provided in a side surface of a vehicle body (1) and singly covering a range corresponding to both a front seat (2) and a rear seat (3), which are installed in a front and in a rear in the vehicle body so as to form two rows of seats in a direction from a front to a rear of the vehicle body;
an opening (5) defined in the vehicle body so as to correspond to the door and having a shape that can coincide with the door when the door is closed;
two first coupling means (34a, 34b, 35a, 35b) placed between the vehicle body and the door and detachably coupling the door to the vehicle body at locations in front and rear ends of the opening of the vehicle body;
a second coupling means (111, 121, 122, 211, 212, 221, 222, 223, 311, 312, 321, 322, 323, 411, 412, 421, 422, 423) placed between the vehicle body and the door and performing at least one of both a rotating motion of the door in a planar surface of the vehicle body and a moving motion in a direction from the front to the rear of the vehicle body, and stopping the door in three door states that are a first door state in which the door is closed, a second door state in which the door is opened within a range corresponding to the front seat in the direction from the front to the rear of the vehicle body, and a third door state in which the door is opened within a range corresponding to both the front seat and the rear seat in the direction from the front to the rear of the vehicle body;
an input unit (10) inputting a manipulation signal indicative of a desired state between the three door states that are the first door state, the second door state and the third door state; and
a control unit (20) receiving the manipulation signal from the input unit and controlling the first coupling means so as to couple or decouple the door to or from the vehicle body, and controlling the second coupling means so as to perform both a rotating motion of the second coupling means relative to the vehicle body and a rotating motion of the door relative to the second coupling means, thereby performing a transition between three door states that are the first door state, the second door state and the third door state.

2. The vehicle door device as set forth in claim 1, wherein
the second coupling means is a link mechanism comprising a link (111), a first rotation drive mechanism (121) and a second rotation drive mechanism (122),
one end of the link is rotatably coupled to a rear end of the opening (5) of the vehicle body (1) in the direction from the front to the rear of the vehicle body by the first rotation drive mechanism, and another end of the link is rotatably coupled to the door (4) by the second rotation drive mechanism, and
the link in the first door state is held in a state in which the link is parallel to an inner surface of the door.

3. The vehicle door device as set forth in claim 1, wherein
the second coupling means is a link mechanism comprising a first link (211, 311), a second link (212, 312), a first rotation drive mechanism (221, 321), a second rotation drive mechanism (222, 322) and a third rotation drive mechanism (223, 323),
one end of the first link is rotatably coupled to one end of the second link by the second rotation drive mechanism, another end of the first link is rotatably coupled to a rear end of the opening (5) of the vehicle body (1) in the direction from the front to the rear of the vehicle body by the first rotation drive mechanism, and another end of the second link is rotatably coupled to approximately a center portion of the door (4) in the direction from the front to the rear of the vehicle body by the third rotation drive mechanism, and
both the first link and the second link in the first door state are extended so as to be held in a state in which the first and second links are in parallel to an inner surface of the door.

4. The vehicle door device as set forth in claim 1, wherein
the second coupling means is a link mechanism comprising a first link (411), a second link (412), a first rotation drive mechanism (421), a second rotation drive mechanism (422) and a third rotation drive mechanism (423),
one end of the first link is rotatably coupled to one end of the second link by the second rotation drive mechanism, another end of the first link is rotatably coupled to a rear end of the opening (5) of the vehicle body (1) in the direction from the front to the rear of the vehicle body by the first rotation drive mechanism, and another end of the second link is rotatably coupled to approximately a rear end of the door (4) in the direction from the front to the rear of the vehicle body by the third rotation drive mechanism, and
the first link and the second link in the first door state are folded on each other so as to be held in a state in which the first and second links are in parallel to an inner surface of the door.

5. The vehicle door device as set forth in claim 1, wherein
the two first coupling means (34a, 34b, 35a, 35b) are placed between the vehicle body (1) and the door (4) and detachably couple the door to the vehicle body at locations in front and rear ends of the opening (5) of the vehicle body in the direction from the front to the rear of the vehicle body; and
a third coupling means (34c, 35c) detachably couples the door to the vehicle body in approximately a lower portion of a center of the opening of the vehicle body in the direction from the front to the rear of the vehicle body, wherein
the two first coupling means and the third coupling means in the first door state fixedly connect the door (4) to the opening (5) in such a way that the door does not move in a direction from the front to the rear and in an upward and downward direction of a planar surface of the door, the two first coupling means and the third coupling means in the first door state thereby forming a triangular truss structure (6) in which the two first coupling means and the third coupling means form respective apexes.
